(19) United States
(12) Patent Application Publication
(10) Pub. No.: US 2017/0024392 A1
(43) Pub. Date: Jan. 26, 2017

(54) METHODS AND SYSTEMS OF BUILDING INTELLIGENT SYSTEMS TO INDEX USER CONTENT FROM MULTIPLE CLOUD-COMPUTING PLATFORMS

(71) Applicants: JAYESH SHAH, HILLSBOROUGH, CA (US); BALKRISHNA HEROOR, MUMBAI (IN); NANDAN UMARJI, MUMBAI (IN)

(72) Inventors: JAYESH SHAH, HILLSBOROUGH, CA (US); BALKRISHNA HEROOR, MUMBAI (IN); NANDAN UMARJI, MUMBAI (IN)

(21) Appl. No.: 15/059,307

(22) Filed: Mar. 3, 2016

Related U.S. Application Data
(60) Provisional application No. 62/127,442, filed on Mar. 3, 2015.
(60) Provisional application No. 62/302,815, filed on Mar. 3, 2016.

(51) Int. Cl. G06F 17/30; G06N 99/00; G06N 7/00

(52) U.S. Cl. CPC G06F 17/3053; G06F 17/30321; G06F 17/3048; G06F 17/30581; G06F 17/30598; G06N 7/00; G06N 99/005

(57) ABSTRACT

In one aspect, a computerized system of an intelligent workspace manager, includes: determining a user context; traversing a set of cloud-computing platforms to obtain a data relevant to a user context; indexing the data relevant to the user context; scoring the data relevant to the user context; ranking the data relevant to the user context; and communicating the data that is most relevant to the user context to one or more user computing devices.

### CROSS-REFERENCE TO RELATED APPLICATIONS

This application is a claims priority from provisional U.S. Application Provisional No. 62/127,442 filed Mar. 3, 2015. This application is hereby incorporated by reference in its entirety. This application is a claims priority from provisional U.S. Application Provisional No. 62/302,815 filed Mar. 3, 2016. This application is hereby incorporated by reference in its entirety.

### FIELD OF THE INVENTION

This application relates generally to cloud computing, and more specifically to a system, article of manufacture and method of indexing user content from multiple cloud-computing platforms.

### DESCRIPTION OF THE RELATED ART

Users may seeks to collaborate on a project. The project may have a particular context (e.g. a goa, one or more topics, a technology to be used, etc.). Users may desire to utilize multiple computers and/or applications to work on the project. Accordingly, improvements to intelligent workspace management systems that are aware of a user's context can increase a user's productivity.

### BRIEF SUMMARY OF THE INVENTION

In one aspect, a computerized system of an intelligent workspace manager, includes: determining a user context; traversing a set of cloud-computing platforms to obtain a data relevant to a user context; indexing the data relevant to the user context; scoring the data relevant to the user context; ranking the data relevant to the user context; and communicating the data that is most relevant to the user context to one or more user computing devices.

In another aspect, a computer system includes: an auto-classification of content means to determine a collaboration topic and predict one or more topics of collaboration, wherein the collaboration is between two more users of an intelligent workspace manager; a caching means to determine a location of the content and cache the content on a set of collaborating user devices; and a content aggregation means to aggregate the content across a set of application services.

### BRIEF DESCRIPTION OF THE DRAWINGS

FIG. 1 illustrates an example system for implementing the following intelligent workspace processes, according to some embodiments.

FIG. 2 illustrates a process of indexing data in one or more cloud-computing platforms that is relevant to a user's context, according to some embodiments.

FIG. 3 illustrates an example process selecting relevant indexed data to download into one or more computing devices, according to some embodiments.

FIG. 4 illustrates an example process determining relevant files stored across multiple cloud-computing platforms to be cached in a user's computing device, according to some embodiments.

FIG. 5 illustrates a process of obtaining predicted relevant content that can be downloaded in a user's computing device, according to some embodiments.

FIG. 6 illustrates an example process of merging contacts from multiple cloud-computing platforms, according to some embodiments.

FIG. 7 illustrates an example process of managing an intelligent workspace that utilized information from multiple cloud-computing platforms, according to some embodiments.

FIG. 8 depicts, in block diagram format, a system for indexing user content from multiple cloud-computing platforms and/or implementing intelligent workspaces, according to some embodiments.

FIG. 9 depicts an exemplary computing system that can be configured to perform any one of the processes provided herein.

FIG. 10 is a block diagram of a sample computing environment that can be utilized to implement various embodiments.

The Figures described above are a representative set, and are not an exhaustive with respect to embodying the invention.

### DESCRIPTION

Disclosed are a system, method, and article of manufacture for indexing user content from multiple cloud-computing platforms. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Example definitions for some embodiments are now provided.

Application programming interface (API) can specify how software components of various systems interact with each other.

Business rules engine can be a software system that executes one or more business rules in a runtime production environment.

Cloud computing can involve deploying groups of remote servers and/or software networks that allow centralized data storage and online access to computer services or resources. These groups of remote serves and/or software networks can be a collection of remote computing services.

Data mining can include the computational process of discovering patterns in large data sets involving methods at the intersection of artificial intelligence, machine learning, statistics, and database systems.

Machine learning systems can include systems that can learn from data, rather than follow explicitly programmed instructions. Machine learning systems can implement various machine learning algorithms, such as, inter alia: supervised learning, unsupervised learning (e.g. artificial neural networks, hierarchal clustering, cluster analysis, association rule learning, etc.), semi-supervised learning, transductive inference, reinforcement learning, deep learning, etc.

Natural language processing (NLP) is a field of computer science, artificial intelligence, and linguistics concerned with the interactions between computers and human (natural) languages. NLP can include natural language understanding and enable computer processes to derive meaning from human or natural language input, and others involve natural language generation.

Regression models be used to establish a mathematical equation as a model to represent the interactions between the different variables in consideration.

A workspace can enable, inter alia, and allow users to collaborate (e.g. communicate via voice, text, images, etc.) and/or exchange and organize files over the Internet and/or other data network.

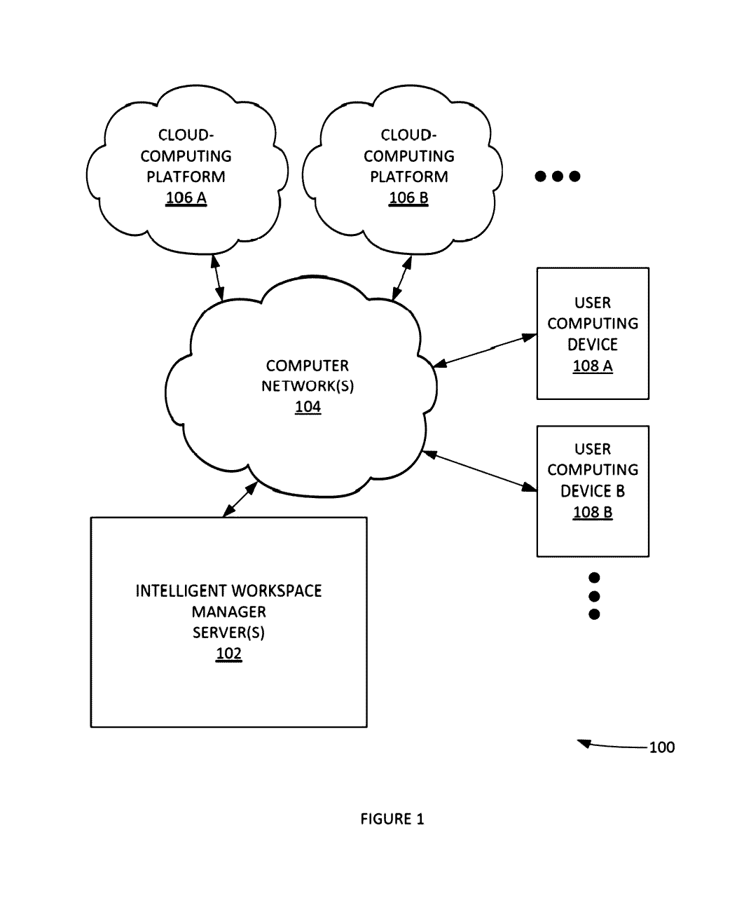

FIG. 1 illustrates an example system 100 for implementing the following intelligent workspace processes, according to some embodiments. System 100 can include intelligent workspace manager server(s) 102. Intelligent workspace manager server(s) 102 can be implement as stand-alone servers and/or in a cloud-computing platform. Intelligent workspace manager server(s) 102 can implement searches of user documents and/or other data in cloud-computing platforms and/or providers 106 A-B. Intelligent workspace manager server(s) 102 can enable users to collaborate and manage documents across cloud computing platforms and cloud-platform providers 106 A-B. Intelligent workspace manager server(s) 102 can various machine learning, data mining and/or NIP functionalities. Intelligent workspace manager server(s) 102 can search various user document sources (e.g. user email databases, user text message databases, user image databases, other user document databases, etc.) and determine various content that may be relevant to current user document collaboration and/or management needs. Intelligent workspace manager server(s) 102 can include a business rule engine. Intelligent workspace manager server(s) 102 can intelligently merge user contacts from various diverse cloud-computing platforms.

Intelligent workspace manager server(s) 102 can manage intelligent workspace application in user computing devices 108 A-B. User computing devices 108 A-B can include desktop computers, laptop computers, mobile devices (e.g. smart phones, wearable computer systems, etc.) and the like. The intelligent workspace application can provide secure mobile productivity for enterprise document sharing. The intelligent workspace application can be operable in various mobile device operating systems (e.g. iOS® and Android®). The intelligent workspace application can provide a virtual workspace for private sharing of documents. For example, the intelligent workspace applications can enable users to create and edit files in Microsoft Office 365® (and other productivity software provider and office suite applications); move and/or copy content across different clouds for sharing; provide a timeline view for documents by user, folder, workspace; etc. Intelligent workspace applications can enable mobile collaboration and document sharing platforms for business users ‘on the go’.

Intelligent workspace manager server(s) 102 can further manage and provide the following functionalities, inter alia: file synchronization, activity notification, intelligent workspaces, integrated chat, business rules for email attachments, etc. Intelligent workspace manager server(s) 102 can access to content on cloud computing platforms and cloud-platform providers 106 A-B (e.g. Office 365, Sharepoint®, Dropbox Box® and other sources).

Example cloud computing platforms and cloud-platform providers 106 A-B can include, inter alia: Google Cloud Platform®, Amazon Web Services® (AWS), various open-source cloud hosting services (e.g. Cloud Foundry, Openshift, etc.), Microsoft's Azure Services Platform®, etc. Example cloud computing platforms and cloud-platform providers 106 A-B can also include file hosting services (such as Dropbox®), file storage and synchronization services (e.g. Google Drive®) and/or cloud storage services.

Computer networks 104 can include a communications network (e.g. a telecommunications network) that allows computers to exchange data. The networked computing devices of system 100 can pass data to each other along various data connections. Computer networks 104 can include the Internet, private enterprise networks and/or various cellular data networks.

### EXEMPLARY METHODS

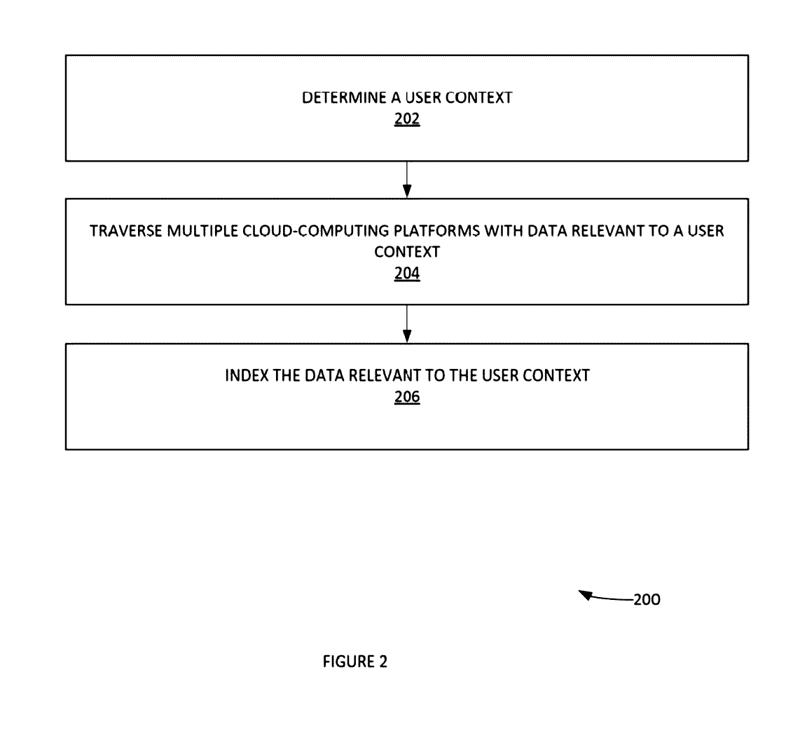

FIG. 2 illustrates a process 200 of indexing data in one or more cloud-computing platforms (e.g. cloud computing platforms and cloud-platform providers 106 A-B) that is relevant to a user's context, according to some embodiments. In step 202 of process 200, a user context can be determined. A user context can be a current user activity. Example user activities can include, inter alia: email composition, text-message composition, workspace collaboration with other users, etc. For example, a user may be drafting an email to a business colleague. In this example, the user's context can be any data in cloud-computing platforms that are relevant (e.g. temporally relevant and/or content-based relevancy) to who the user is communicating with, documents that can be shared by the user, etc.

In step 204, the multiple cloud-computing platforms with relevant data can be traversed. The multiple cloud-computing platforms can be searched and search results obtained. For example, multiple drivers, email systems, workspaces, etc. can be connected to and searches of said entities can be performed (e.g. via an application programming interface (API) provided by said entities.

In step 206, once the relevant data is located in the multiple cloud-computing platforms, the relevant data can be indexed. Indexing can include generating indirect shortcuts derived from and/or pointing into the actual location of the relevant data in the multiple cloud-computing networks. Metadata can also be indexed as well. It is noted that process 200 involves synchronization of data in the cloud-computing entities with an accessible set of indexes instead of accessing of the multiple cloud-computing entitles and downloading all the relevant data. Some portion of the relevant data (e.g. the most relevant data as scored and/or ranked according to a specified metric such as recency in time, etc.) may be downloaded. This ‘highly relevant’ data may be made available even when the user's computing device is in an offline mode or state. In the event the relevant data is not downloaded, the user's application can access the relevant data in the various multiple cloud-computing platforms via the index. The indexes created using process 200 can be periodically updated (e.g. as determined by a system administrator setting, based on type of data, based on recency in time of data, etc.). In one example, if recency is a factor in determining the relevancy of the data, then process 200 can be performed on a shorter period.

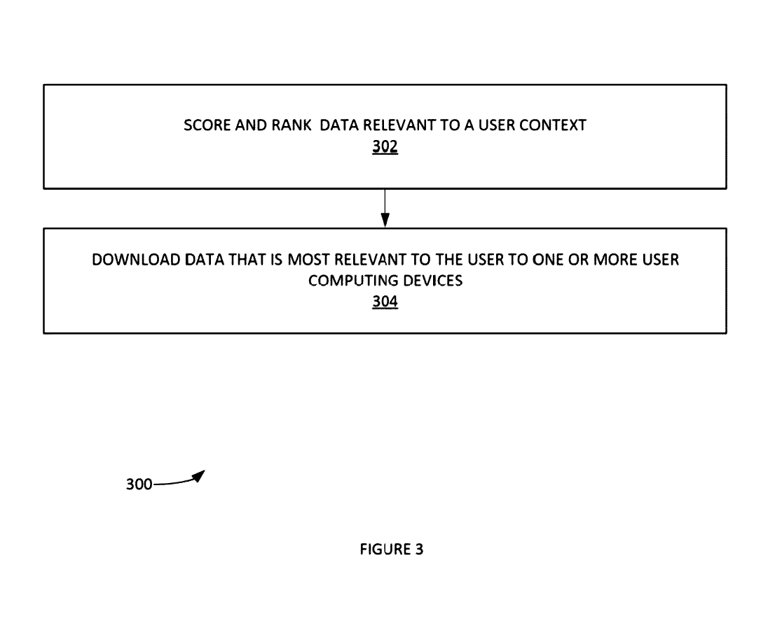

FIG. 3 illustrates an example process 300 selecting relevant indexed data to download into one or more computing devices, according to some embodiments. Process 300 can be integrated into process 200 for implementation. As discussed supra, selected portions of the relevant indexed data may be downloaded into a user-side computing device. In this way, these selected portions can be made available even when the user is offline. For example, the user's context can be determined. Accordingly, in step 302 of process 300, the relevant indexed data can be scored and ranked based on the relevancy of the relevant indexed data to the current user context. Predications (e.g. linear regression-based prediction models) can be utilized to determine a future user context. Relevancy can also be determined according to various other metrics such as those provided herein, as well as, size of files, type of user-computer device, type of application that utilizes the data, etc. The linear regression models can analyze the relationship between the response or dependent variable and a set of independent or predictor variables. This relationship can be expressed as an equation that predicts the response variable as a linear function of the parameters. These parameters are adjusted so that a measure of fit is optimized. Models that minimize the size of the residual, as well as ensuring that it is randomly distributed with respect to the model predictions can be selected and utilized. Exemplary prediction analytics that be utilized (in addition to linear regression-based prediction models) can include, inter alia: discrete choice models, logistic regression, probit regression, multinomial logistic regression, time series models, survival or duration analysis, machine learning techniques (e.g. neural networks, radial basis functions, multilayer perceptrons (MLP), geospatial prediction modeling, geospatial predictive modeling, etc.), etc. In step 304, the data that is determined to be most relevant to the user's context can be downloaded to the user's computing device. This data can be periodically synchronized and/or refreshed to ensure that it remains current.

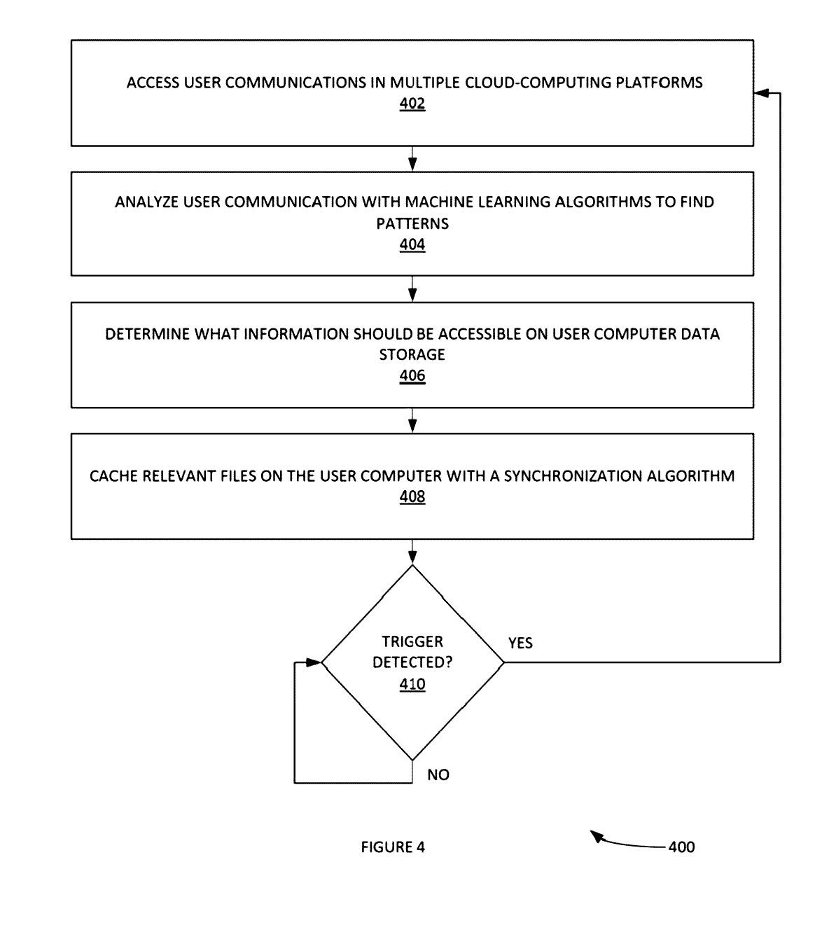

FIG. 4 illustrates an example process 400 determining relevant files stored across multiple cloud-computing platforms to be cached in a user's computing device, according to some embodiments. Process 400 can be utilized as an example process for determining relevant content to a user's context with respect to user communications (e.g. emails, text messages, instant messages, etc.). User communications can be stored in multiple cloud-computing platforms. For example, a user may have one or more personal email accounts. The user may have a Yahoo® email account, a Gmail account, etc. The content of these various email accounts can be stored in different cloud-computing platforms managed by Yahoo®, Google®, etc. Process 400 can index the email content in the various email accounts and download the email content that is most relevant to a user's current context (e.g. most relevant to an email thread between the user other persons the user is most likely to email, most relevant to the user in terms of recency of email conversation, most relevant to another task the user is performing in an intelligent workspace, etc.).

More specifically, in step 402 of process 400, user communication in multiple cloud-computing platforms can be accessed. For example user emails can be accessed. User text messages can be accessed. User voice-mail messages can be accessed.

In step 404, the user communications can be analyzed with, inter alia, machine learning patterns to various patterns. Example machine learning algorithms include, inter alia: supervised learning algorithms (e.g. artificial neural networks, Bayesian statistics, Case-based reasoning, Inductive logic programming, Gaussian process regression, Gene expression programming, Group method of data handling (GMDH), Learning Automata, Learning Vector Quantization, Logistic Model Tree, ANOVA, nearest k, Lazy learning, Instance-based learning, etc.); unsupervised learning algorithms (e.g. Association rule learning, Apriori algorithm, Eclat algorithm, FP-growth algorithm, Hierarchical clustering, Single-linkage clustering, Conceptual clustering, Cluster analysis, Outlier Detection, etc.); Reinforcement Learning; Deep Learning; etc. Patterns can include temporal patterns (e.g. when communications were made and/or received), contact patterns (e.g. addressees of communications), content patterns (e.g. content and/or subject matter of communications, common terms in communications, etc.), and the like. This information and the location of the communications in the various multiple cloud-computing platforms can be indexed for later retrieval.

In step 406, what information that should be retrievable by a user can be determined. This information can be retrievable when the user's computing device cannot access the Internet or one or more of the multiple cloud-computing platforms. For example, various information categories can be scored and/or ranked based on various factors such as a user's current activity and/or other context and/or a user predicted activity and/or other context. For example, it can be determine that a user is having an important conversation via text message and email. Accordingly, all communications recently related (e.g. within the past month) to the other users in this conversation and/or other users predicted to become important to this conversation can be determined to be retrievable by the user.

In step 408, the relevant files (e.g. as determine in step 406) can be cached in one or more user computing devices with a synchronization algorithm. In step 410, it can be determined if a trigger to repeat process 400 has been detected? In one example, process 400 can be performed on a periodic basis. In another example, process 400 can be repeated based on other factors such as: when it is detected that a user's mobile device may soon be offline, when it is detected that the user is engaging in an important conversation, etc.

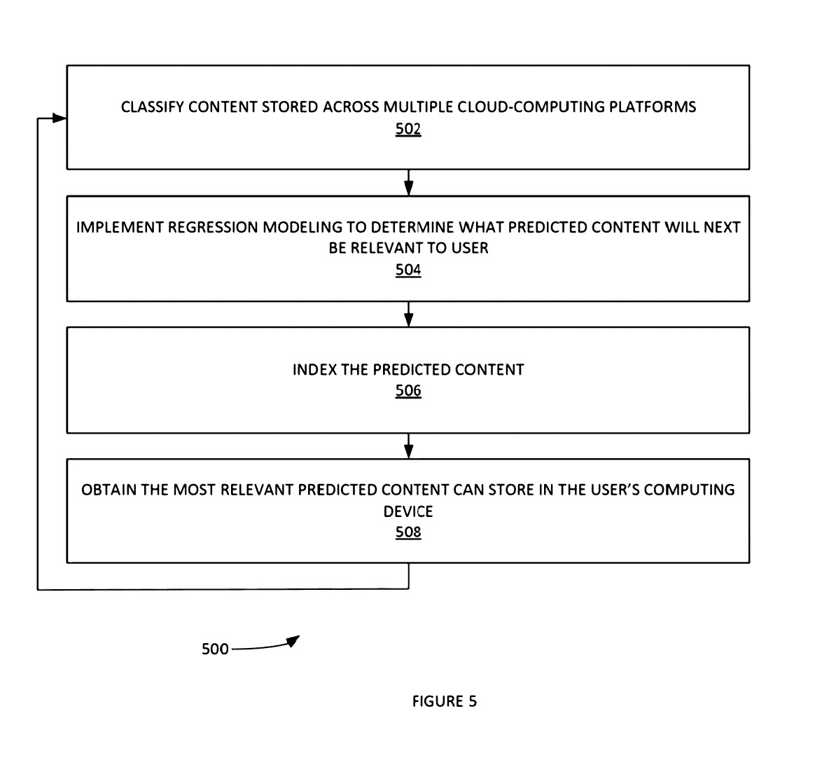

FIG. 5 illustrates a process 500 of obtaining predicted relevant content that can be downloaded in a user's computing device, according to some embodiments. In step 502, the user's content across multiple cloud-computing platforms can be classified. Classification can including categorization (e.g. the process in which ideas and objects are recognized and/or differentiated) of each content entity (e.g. contact entity, a text file, a media file, an email, etc.). In step 504, regression models can be implemented to determine what predicted content will be relevant to the user. For example, a user may be collaborating with another user in an intelligent workspace. It can be predicted that the user will be likely to use the other user's email and/or other contacts.

In step 506, the predicted content can be indexed. In step 508, the most relevant predicted content can be stored in a user's computing device. For example, relevancy can be determined based on the variables used in the prediction algorithms.

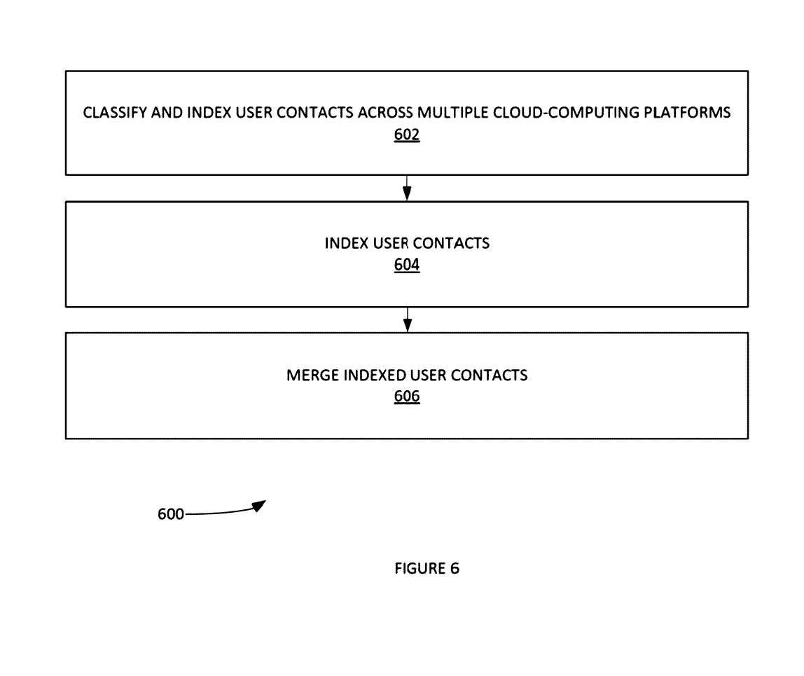

FIG. 6 illustrates an example process 600 of merging contacts from multiple cloud-computing platforms, according to some embodiments. The contacts can be taken from various contact lists. A contact list can be a collection of screen names (e.g. from an instant messaging application, an e-mail program, an online game, a mobile phone contact list, a CRM marketing and management application, etc.). In step 602 of process 600, user contacts across multiple cloud-computing platforms can be classified. In one example, a single contact can be derived from multiple applications with different names for the contact. Machine learning and/or prediction algorithms can be utilized to match variant names for the same contact.

In step 604, the classified contacts can be indexed. Index elements can point to the various contact data in the multiple cloud-computing platforms without downloads all the contacts to a local user computer system. In step 606, the indexed contacts can be merged and the index can be downloaded into the user computer system. It is noted that the most important contacts (e.g. the highest ranked contacts based on a user context) can be downloaded into the local user computer system.

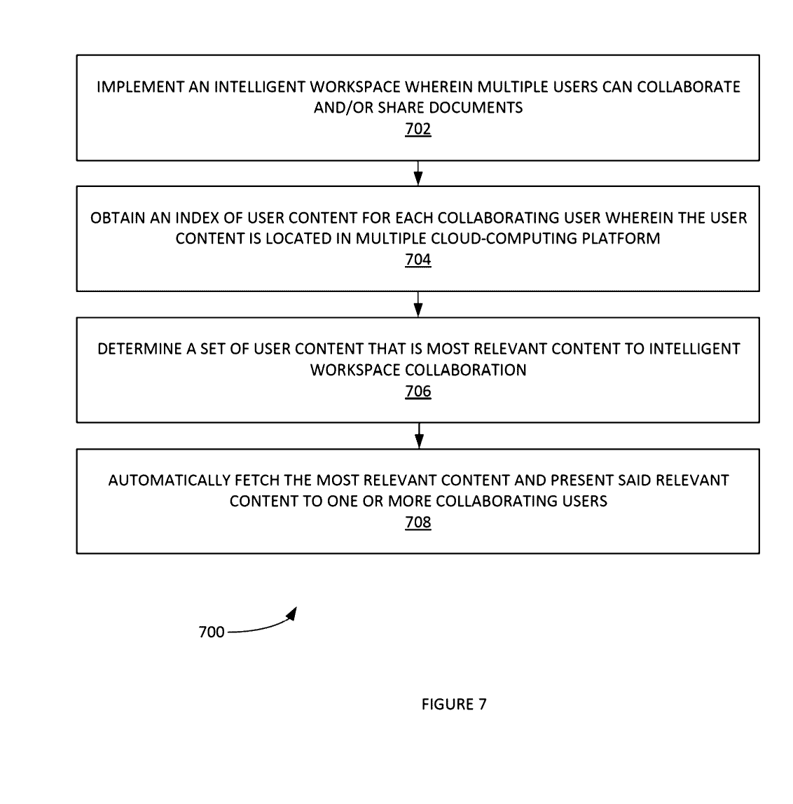

FIG. 7 illustrates an example process 700 of managing an intelligent workspace that utilized information from multiple cloud-computing platforms, according to some embodiments. Intelligent workspaces can be accessed and/or utilized forma client-side computing system such a mobile device. Users can utilized intelligent workspace to share file/email/contact with colleagues (e.g. In the user's company) or people (e.g. outside the user's company). User can access can access an intelligent workspace by accessing a URL (e.g. similar to access a Dropbox® or a Google® drive). When an intelligent workspace is accessed, a user can view how many times the files were opened and the names of said files. These files may have been shared with other users (e.g. colleagues, customers, etc.). For example, metrics on which customers opened presentations and other filing opening analytics (when, how many times, etc.) can be provided to the user via the intelligent workspace. The intelligent workspace can present analytics of the files associated with the user and the content of each file. The user can determine out how data in a file was accessed and what data exists in files across multiple clouds and/or enterprise directories. A user can access enterprise data for a specified vertical. A user can use an intelligent workspace to send documents/files to other users.

In step 702 of process 700, an intelligent workspace can be implemented wherein multiple users can collaborate and/or share documents. In step 704, an index of user content can be obtained for each collaborating user wherein the user content is located in multiple cloud-computing platform. In step 706, a set of user content that is most relevant content to intelligent workspace collaboration can be determined. Step 708 can include automatically fetching the most relevant content and present said relevant content to one or more collaborating users.

### Additional Exemplary Computer Architecture and Systems

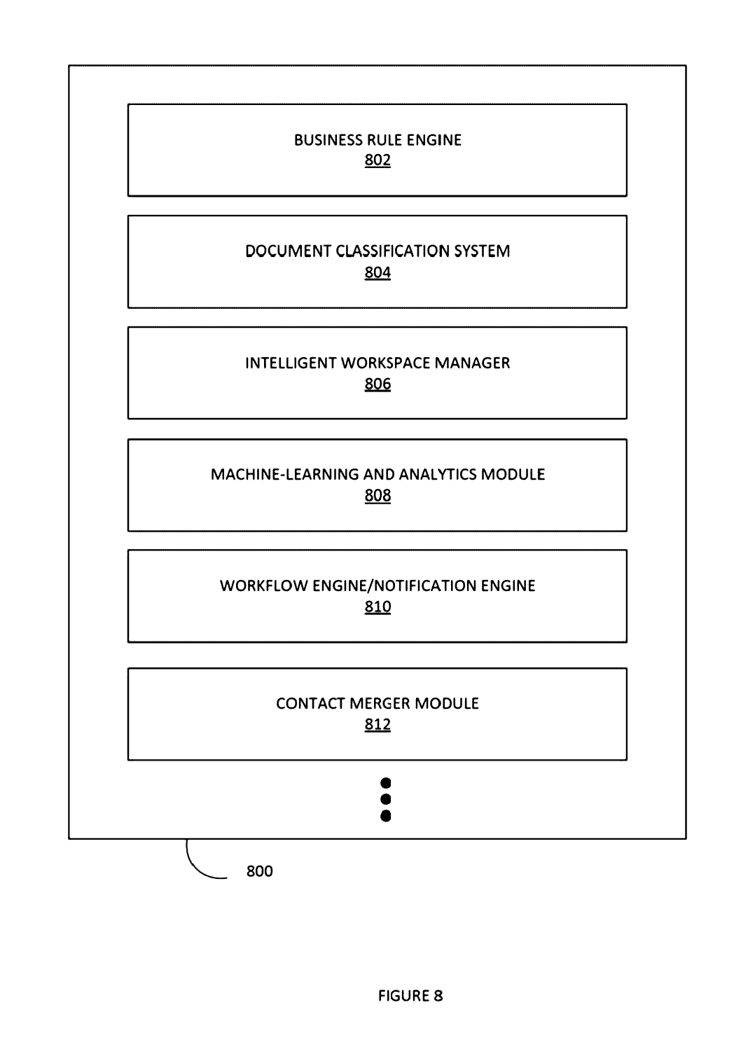

FIG. 8 depicts, in block diagram format, a system 800 for indexing user content from multiple cloud-computing platforms and/or implementing intelligent workspaces, according to some embodiments. System 800 can implement processes 100, 200, 300, 400, 500, 600 and 700.

Business rule engine 802 can perform various functionalities associated with indexing operations. Business rule engine 802 can classify user content. For example, business rule engine 802 can classify user emails into multiple folders (e.g. based on sender identity, persons/entities who were cc'ed in each email, etc.). Business rule engine 802 can move attachment from email files to a specified location. For example, business rule engine 802 can move all a user's attachments from various designated emails to a specified cloud-based drive or file hosting service (e.g. a Dropbox® file, a Google Drive®, another file storage and synchronization service, etc.). Business rule engine 802 can create rules that govern user experience and/or functions in the system 800. Users can customize certain rules. Business rule engine 802 can implement attachment movement and/or moving of a specified folder inside an email system.

Document classification module 804 can traverse user data in multiple cloud-computing platforms to determine entities. Document classification module 804 can monitor user content, understand what it means and classify it to an intelligent workspace. Document classification module 804 can use natural language processing solutions for finding out the entities. Document classification module 804 can determine both entities and sentiments about entities. Document classification module 804 can determine the importance of the entities and relations between the entities using graph models. Document classification module 804 can classify documents under multiple work spaces as well. Multiple technologies can be grouped together to deliver the result of document classification. In this way, classified user content can be automatically moved to workspaces.

Intelligent workspace manager 806 can implement intelligent workspaces. Users can use intelligent workspaces to collaborate on one or more projects. Intelligent workspaces can predict what user content will be needed in the future and obtain said user content. Intelligent workspace manager 806 can leverage machine learning and analytics module 808 to implement various prediction models and/or optimize predictions.

Machine learning and analytics module 808 can implement various machine learning, optimization, analytics and/or prediction algorithms (e.g. such as those provided supra). Machine learning and analytics module 808 receive requests from the other modules and/or processes of system 800 to provide predictions and return said predictions. Machine learning and analytics module 808 can perform data mining operations across the user data in multiple cloud-computing platforms. For example, machine learning and analytics module 808 can perform anomaly detection operations (e.g. outlier/change/deviation detection), Association rule learning (dependency modelling), clustering operations, classification operations, regression operations and/or summarization operations.

System 800 can include additional functionalities such as, inter alia: search engines, web servers, mobile application managers, API's, autocomplete engines, predictive text engines, file-sharing applications, etc. System 800 can search is across email service providers, chat providers, user documents on different clouds and/or across different silo solutions. System 800 can include functionalities to take snap shot of these files/documents in clouds and provide the location to the user. System 800 can include an application global search feature that enables a search of all the user's data storage drives. System 800 can learn user priorities (e.g. what the user is trying to say when typing a search string).

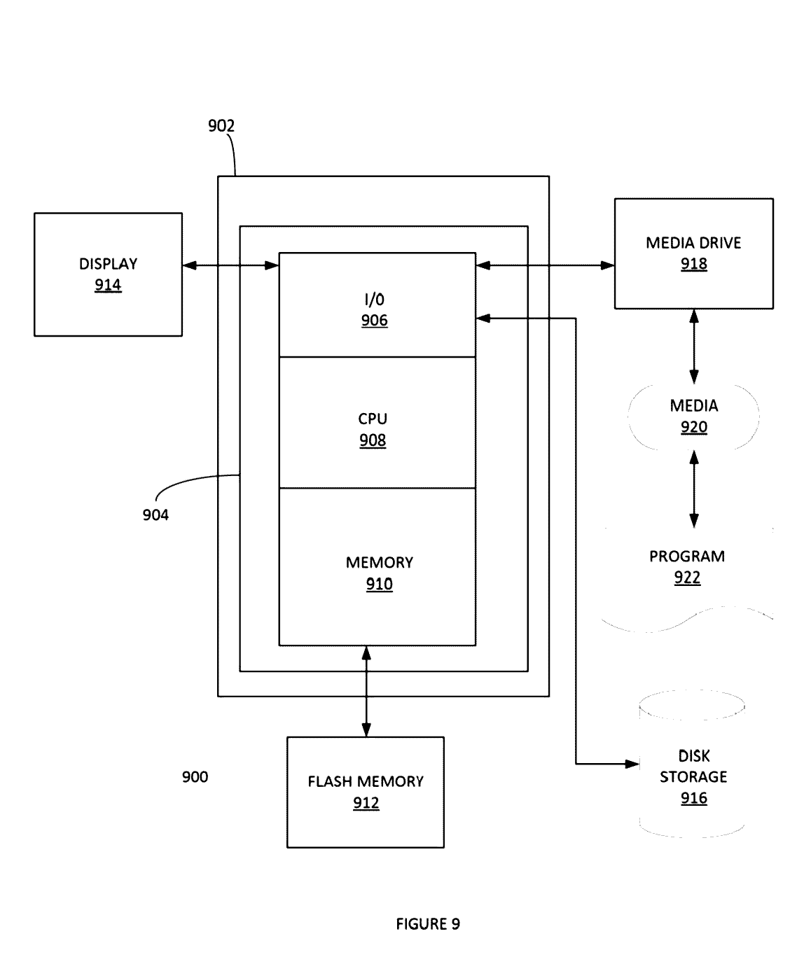

FIG. 9 depicts an exemplary computing system 900 that can be configured to perform any one of the processes provided herein. In this context, computing system 900 may include, for example, a processor, memory, storage, and I/O devices (e.g., monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 9 depicts computing system 900 with a number of components that may be used to perform any of the processes described herein. The main system 902 includes a motherboard 904 having an I/O section 906, one or more central processing units (CPU) 908, and a memory section 910, which may have a flash memory card 912 related to it. The I/O section 906 can be connected to a display 914, a keyboard and/or other user input (not shown), a disk storage unit 916, and a media drive unit 918. The media drive unit 918 can read/write a computer-readable medium 920, which can contain programs 922 and/or data. Computing system 900 can include a web browser. Moreover, it is noted that computing system 900 can be configured to include additional systems in order to fulfill various functionalities. Computing system 900 can communicate with other computing devices based on various computer communication protocols such a WI-Fi, Bluetooth® (and/or other standards for exchanging data over short distances includes those using short-wavelength radio transmissions), USB, Ethernet, cellular, an ultrasonic local area communication protocol, etc.

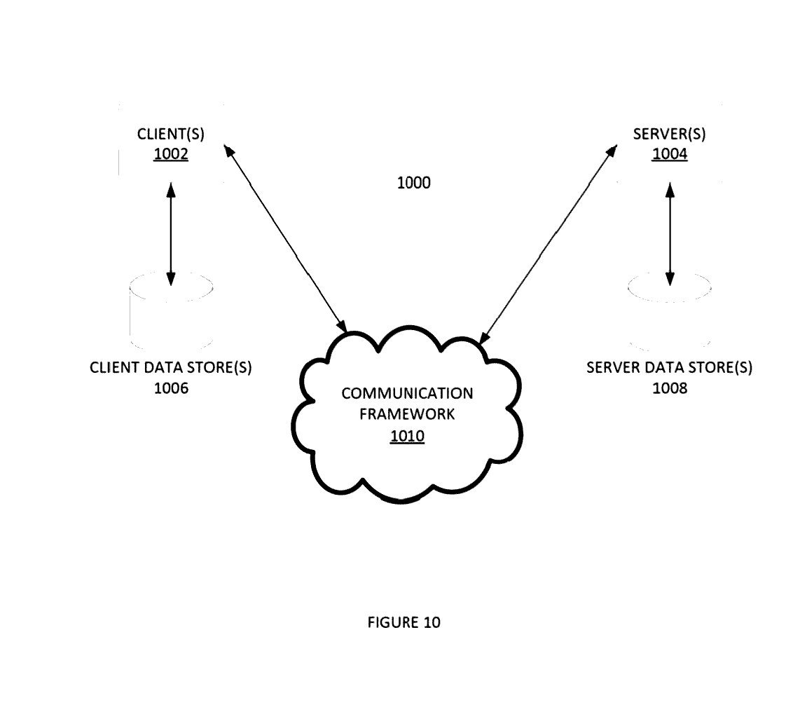

FIG. 10 is a block diagram of a sample computing environment 1000 that can be utilized to implement various embodiments. The system 1000 further illustrates a system that includes one or more client(s) 1002. The client(s) 1002 can be hardware and/or software (e.g., threads, processes, computing devices). The system 1000 also includes one or more server(s) 1004. The server(s) 1004 can also be hardware and/or software (e.g., threads, processes, computing devices). One possible communication between a client 1002 and a server 1004 may be in the form of a data packet adapted to be transmitted between two or more computer processes. The system 1000 includes a communication framework 1010 that can be employed to facilitate communications between the client(s) 1002 and the server(s) 1004. The client(s) 1002 are connected to one or more client data store(s) 1006 that can be employed to store information local to the client(s) 1002. Similarly, the server(s) 1004 are connected to one or more server data store(s) 1008 that can be employed to store information local to the server(s) 1004. In some embodiments, system 1000 can instead be a collection of remote computing services constituting a cloud-computing platform. Systems 800, 900 and 1000, as well as the systems of FIG. 1, can be used to implement the process flows of FIGS. 2-7.

Data Indexing Methods

To improve performance and user experience ‘Data Indexing Method’ keeps file objects that are likely to be used in the near future close to the client. Most of the current applications still employ traditional caching policies that are not efficient in file caching. This system uses a splitting client-side file cache to two caches, short-term cache and long-term cache. Primarily, a file object is stored in short-term cache, and the file objects that are opened more than the pre-specified threshold value will be moved to long-term cache, while other objects are removed by Least Recently Used (LRU) algorithm as short-term cache is full. More significantly, when the long-term cache saturates, the trained neuro-fuzzy system is employed in classifying each object stored in long-term cache into cacheable or uncacheable object. The old uncacheable objects are candidate for removing from the long-term cache. By implementing this mechanism, the cache pollution can be mitigated and the cache space can be utilized effectively.

Intrinsic Importance Algorithms

This thesis models priority in terms of intrinsic importance, although we collected the importance and the urgency of the content, known as content priority matrix. The importance stands for how important the content is to the recipient and urgency stands for how urgent the content is to the recipient with respect to the recipient's reaction. For instance, if the content is related to a grant proposal and the recipient is actively engaged, then the importance of contents belongs to this grant proposal is very high. However, if a content has no specific deadline, the urgency of the content is not very urgent. System modeled the criticality as their priority. We defined the criticality of a notification as the expected cost of delayed action associated with reviewing the message, which modeled in terms of only the urgency.

The same terminology, the priority, for these two different factors, the urgency and the importance, is that both factors contribute to the priority. Priority is modeled with five levels in terms of importance. Priority modeled priority into two levels, high and low priority. In that case, it is similar to spam filtering. So we do not set just two levels. To make prioritization system realistic, at least three levels or more are required, low, medium, and high.

The other approach is only a rank based priority which sorts all unread contents. It could be natural to sort unread contents we have modeled 100 levels from 1 to 100 during evaluation. Even this 100 levels are quite fuzzy to the users too because a user may have difficulty in distinguishing between 32 and 33 priority levels. Instead of requesting every regression levels, we may learn a partial rank based preference function to alleviate heavy load labeling burden. But it may not be able to associate the predicted rank with certain actions. For instance, depending on the priority levels, we may provide content coloring to show importance level or send NOTIFICATION message to one's cell phone.

Graph Models

Graph Models are built using Bayesian network, Bayes network, belief network, Bayes(ian) model or probabilistic directed acyclic graphical model is a probabilistic graphical model (a type of statistical model) that represents a set of random variables and their conditional dependencies via a directed acyclic graph (DAG). We have represented the probabilistic relationships between documents and people. Given people, the network can be used to compute the probabilities of the importance of various documents.

Some systems herein can perform inference and learning in Bayesian networks. Bayesian networks that model sequences of variables (e.g. speech signals or protein sequences) are called dynamic Bayesian networks. Following example shows a big picture of the concepts used in algorithm

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, t can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized system of an intelligent workspace manager, comprising:
determining a user context;
traversing a set of cloud-computing platforms to obtain a data relevant to a user context;
indexing the data relevant to the user context;
scoring the data relevant to the user context;
ranking the data relevant to the user context; and
communicating the data that is most relevant to the user context to one or more user computing devices.

2. The computerized system of claim 1, wherein the user content comprises an email composition, a text-message composition or a workspace collaboration with other users.

3. The computerized system of claim 2, wherein the relevancy is determined based on a size of file in the user content, a type of user-computer device in the user content and a type of application in the user content that utilizes the data.

4. The computerized system of claim 3, wherein the relevancy is determined using a linear regression-based prediction model.

5. The computerized system of claim 4, wherein the data relevant to the user context is relevant to a collaboration topic.

6. The computerized system of claim 5 further comprising:
accessing a set of user communications of the user in the set of cloud-computing platforms.

7. The computerized system of claim 6 further comprising:
analyzing each user communication with a set of machine learning algorithms to determine a set of information to make accessible on at least one user computer data storage.

8. The computerized system of claim 7 further comprising:
caching a set of relevant files on the user computer with a synchronization algorithm.

9. The computerized system of claim 8 further comprising:
determining a multiple user context for each of a set of multiple users;
traversing a set of cloud-computing platforms to obtain a set of data relevant to the multiple user context.
indexing the set of the data relevant to the multiple user context;
scoring the set of the data relevant to the multiple user context;
ranking the set of the data relevant to the multiple user context; and
communicating the set of the data relevant to the multiple user context to one or more user computing devices.

10. A computer system for implementing an intelligent workspace manager, the proxy-server system comprising:
memory configured to store a set of instructions used to implement the search; and
one or more processors configured to:
determine a user context;
traverse a set of cloud-computing platforms to obtain a data relevant to a user context;
index the data relevant to the user context;
score the data relevant to the user context;
rank the data relevant to the user context; and
communicate the data that is most relevant to the user context to one or more user computing devices.

11. The computer system of claim 10, wherein the user content comprises an email composition, a text-message composition or a workspace collaboration with other users.

12. The computer system of claim 11, wherein the relevancy is determined based on a size of file in the user content, a type of user-computer device in the user content and a type of application in the user content that utilizes the data.

13. The computer system of claim 12, wherein the relevancy is determined using a linear regression-based prediction model.

14. The computer system of claim 12, wherein the data relevant to the user context is relevant to a collaboration topic.

15. A computer system comprising:
an auto-classification of content means to determine a collaboration topic and predict one or more topics of collaboration, wherein the collaboration is between two more users of an intelligent workspace manager;
a caching means to determine a location of the content and cache the content on a set of collaborating user devices; and
a content aggregation means to aggregate the content across a set of application services.

16. The computer system of claim 15, wherein the

17. The computer system of claim 16, wherein the content is cached in both a user device and a cloud-computing platform.
